(19) United States
(12) Patent Application Publication
(10) Pub. No.: US 2021/0081634 A1
(43) Pub. Date: Mar. 18, 2021

(54) FINGERPRINT RECOGNITION MODULE AND DRIVING METHOD THEREOF, AND DISPLAY DEVICE

(71) Applicant: BOE Technology Group Co., Ltd., Beijing (CN)

(72) Inventors: Yingming Liu, Beijing (CN); Haisheng Wang, Beijing (CN); Xiaoliang Ding, Beijing (CN); Pengpeng Wang, Beijing (CN); Xiufeng Li, Beijing (CN); Yuzhen Guo, Beijing (CN); Ruituo Wang, Beijing (CN)

(73) Assignee: BOE Technology Group Co., Ltd.

(21) Appl. No.: 16/834,765

(22) Filed: Mar. 30, 2020

(30) Foreign Application Priority Data
Sep. 16, 2019 (CN) 201910870217.0

(51) Int. Cl. G06K 9/00

(52) U.S. Cl. CPC G06K 9/0002; G06K 9/00053

(57) ABSTRACT

A fingerprint recognition module and a driving method thereof, and a display device. The fingerprint recognition module includes a substrate, an electrode layer located on one side of the substrate, a piezoelectric film layer located on one side, away from the substrate, of the electrode layer, and a reference electrode layer located on one side, away from the electrode layer, of the piezoelectric film layer, wherein the electrode layer includes a plurality of receiving electrodes arranged in an array and a plurality of transmitting electrodes, and the receiving electrodes and the transmitting electrodes are insulated from each other and are spaced with each other.

### CROSS-REFERENCE TO RELATED APPLICATION

This application claims priority of Chinese Patent Application No. 201910870217.0, filed on Sep. 16, 2019, which is hereby incorporated by reference in its entirety.

### FIELD

The present disclosure relates to the technical field of fingerprint recognition, and in particular relates to a fingerprint recognition module and a driving method thereof, and a display device.

### BACKGROUND

With rapid development of economy and technology, a full screen proposes a requirement on fingerprint recognition that a fingerprint can be captured at any position on a display panel, after which it is not required to form a hole in front glass, thereby greatly increasing consistency of mobile phones' appearances. At present, there are two technical directions to realize the requirement: one is optical fingerprint recognition and the other is ultrasonic fingerprint recognition.

### SUMMARY

An embodiment of the present disclosure provides a fingerprint recognition module, including a substrate, an electrode layer located on one side of the substrate, a piezoelectric film layer located on one side, away from the substrate, of the electrode layer, and a reference electrode layer located on one side, away from the electrode layer, of the piezoelectric film layer, wherein

the electrode layer includes a plurality of receiving electrodes arranged in an array and a plurality of transmitting electrodes, and the receiving electrodes and the transmitting electrodes are insulated from each other and spaced with each other.

In a possible implementation, the transmitting electrodes is strip-shaped and the plurality of transmitting electrodes extend along a same direction.

In a possible implementation, the transmitting electrodes are in one-to-one corresponding to rows of the receiving electrodes, and one transmitting electrode is arranged at a gap between every adjacent rows of the receiving electrodes.

In a possible implementation, the transmitting electrodes are in one-to-one corresponding to columns of the receiving electrodes and one transmitting electrode is arranged at a gap between everyone adjacent columns of the receiving electrodes.

In a possible implementation, the transmitting electrodes are in one-to-one corresponding to rows of the receiving electrodes, the transmitting electrodes respectively surround one row of the receiving electrodes, and a first hollow area is formed at a position corresponding to each of the receiving electrodes in rows, and an orthographic projection of the first hollow area on the substrate covers an orthographic projection of a corresponding receiving electrode on the substrate.

In a possible implementation, the transmitting electrodes are in one-to-one corresponding to columns of the receiving electrodes, the transmitting electrodes respectively surround one column of the receiving electrodes, and a second hollow area is formed at a position corresponding to each of the receiving electrodes in the column, and an orthographic projection of the second hollow area on the substrate covers an orthographic projection of a corresponding receiving electrodes on the substrate.

In a possible implementation, the electrode layer further includes transmitting connection lines in a bezel area of the fingerprint recognition module, and the transmitting connection lines are electrically connected to the transmitting electrodes in a one-to-one corresponding manner.

In a possible implementation, the fingerprint recognition module further includes recognition circuits in one-to-one corresponding to the receiving electrodes, and scanning signal lines in electrical connection to the recognition circuits, and reading signal lines in electrical connection to the recognition circuits, the recognition circuits being configured to read signals received by the receiving electrodes through the reading signal lines in response to that the scanning signal lines are switched on.

In a possible implementation, one side, away from the piezoelectric film layer, of the reference electrode layer is further provided with a protection layer.

In a possible implementation, the piezoelectric film layer is a whole film layer.

In a possible implementation, the reference electrode layer is a whole film layer.

An embodiment of the present disclosure further provides a display device including a display panel and further including the fingerprint recognition module provided by the embodiment of the present disclosure, wherein the fingerprint recognition module is located at a non-display side of the display panel.

An embodiment of the present disclosure further provides a driving method of the fingerprint recognition module provided by the embodiment of the present disclosure, including:

at a transmitting stage, controlling a reference electrode layer to be loaded with a first constant potential, and controlling the transmitting electrodes to be loaded with changing electrical signals; and

at a receiving stage, controlling the reference electrode layer to be loaded with a second constant potential and the receiving electrodes to receive electrical signals converted from ultrasonic signals reflected via a finger.

In a possible implementation, controlling the transmitting electrodes to be loaded with changing electrical signals includes:

controlling the transmitting electrodes to be loaded with the changing electrical signals in order; and

in response to that the current transmitting electrode is loaded with the changing electrical signals, controlling the plurality of adjacent transmitting electrodes to be loaded with the electrical signals before a preset duration, so as to focus a plurality of ultrasonic signals correspondingly transformed from a plurality of electrical signals at different positions in order.

An embodiment of the present disclosure further provides a position recognition method applied to the fingerprint recognition module provided by the embodiment of the present disclosure, including:

controlling the recognition circuits to read electrical signals as corresponding positional information of the receiving electrodes, wherein the electrical signals are converted from ultrasonic signals reflected via a finger and received by the receiving electrodes.

### BRIEF DESCRIPTION OF THE DRAWINGS

FIG. 1 is a structural schematic diagram of a fingerprint recognition module provided by an embodiment of the present disclosure;

FIG. 2 is a structural schematic diagram of an electrode layer of transmitting electrodes located at a gap between adjacent rows of receiving electrodes provided by an embodiment of the present disclosure;

FIG. 3 is a structural schematic diagram of an electrode layer of transmitting electrodes located at a gap between adjacent columns of receiving electrodes provided by an embodiment of the present disclosure;

FIG. 4 is a structural schematic diagram of an electrode layer of transmitting electrodes located at a position where the row of receiving electrodes is located, provided by an embodiment of the present disclosure;

FIG. 5 is a structural schematic diagram of an electrode layer of transmitting electrodes located at a position where the column of receiving electrodes is located, provided by an embodiment of the present disclosure;

FIG. 6 is a structural schematic diagram of an electrode layer including leading wires of transmitting electrodes, provided by an embodiment of the present disclosure;

FIG. 7 is another structural diagram of an electrode layer including leading wires of transmitting electrodes, provided by an embodiment of the present disclosure;

FIG. 8 is a schematic diagram of an identification module provided by an embodiment of the present disclosure;

FIG. 9 is a schematic diagram of a fingerprint recognition module including a protection layer, provided by an embodiment of the present disclosure;

FIG. 10 is a structural schematic diagram of a display device provided by an embodiment of the present disclosure;

FIG. 11 is a flow chart of a driving method of a fingerprint recognition module provided by an embodiment of the present disclosure;

FIG. 12 is a schematic diagram of transmitting acoustic signals provided by an embodiment of the present disclosure;

FIG. 13 is a schematic diagram of receiving acoustic signals provided by an embodiment of the present disclosure.

### DETAILED DESCRIPTION OF THE EMBODIMENTS

In order to make the purpose, the technical solutions and the advantages of the embodiments of the present disclosure clearer, accompanying drawings in the embodiments of the present disclosure will be incorporated below to describe the technical solutions of the embodiments of the present disclosure completely and clearly. Obviously, the embodiments described are a part of embodiments of the present disclosure, rather than all embodiments. Based on the embodiments of the present disclosure described, all other embodiments obtained by ordinary those skilled in the art under the precondition of not paying any inventive labor should belong to the protection scope of the present disclosure.

Unless otherwise defined, the technical terms or scientific terms used in the present disclosure should have the general meanings as understood by those skilled in the art in the field to which the present disclosure belongs. “First”, “second” and similar words used in the present disclosure do not indicate any sequence, number or importance, but are merely used to distinguish different components. “Comprise” or “include” and other similar words indicate elements or objects appearing before the words or cover elements or objects and equivalents thereof listed after the words, without excluding other elements or objects. “Connection” or “link” and other similar words are not defined to physical or mechanical connection, but also include electrical connection, including both direct and indirect. “Up”, “down”, “left”, “right” and the like are merely used to indicate relative position relationship, and after the absolute position of an object described changes, the relative position relationship is also likely to change accordingly.

In order to keep the following description of the embodiments of the present disclosure clear and concise, the present disclosure omits detailed description of known functions and known parts.

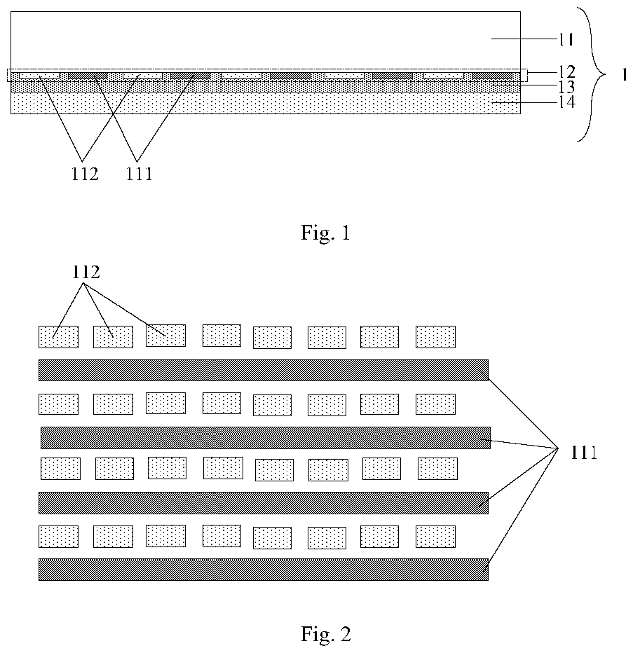

Referring to FIG. 1, an embodiment of the present disclosure provides a fingerprint recognition module, including a substrate 11, an electrode layer 12 located on one side of the substrate 11, a piezoelectric film layer 13 located on one side, away from the substrate 11, of the electrode layer 12, and a reference electrode layer 14 located on one side, away from o the electrode layer 12, of the piezoelectric film layer 13, wherein the electrode layer 12 includes a plurality of mutually insulated receiving electrodes 112 arranged in an array and a plurality of transmitting electrodes 111 located at gaps between the receiving electrodes 112, that is, the receiving electrodes 112 and the transmitting electrodes 111 are spaced with each other, wherein the receiving electrodes 112 and the transmitting electrodes 111 are insulated from each other.

The fingerprint recognition module provided by the embodiment of the present disclosure includes the substrate 11, the electrode layer 12 located on one side of the substrate 11, the piezoelectric film layer 13 located on one side, away from the substrate 11, of the electrode layer 12, and a reference electrode layer 14 located on one side, away from the electrode layer 12, of the piezoelectric film layer 13, wherein the electrode layer 12 includes the plurality of receiving electrodes 112 arranged in an array and the plurality of transmitting electrodes 111 located at the gaps between the receiving electrodes 112, and the receiving electrodes and the transmitting electrodes are insulated from each other. When transmitting acoustic signals, by applying a constant potential to the reference electrode layer 14 and loading changing electrical signals to the transmitting electrodes 111, the piezoelectric film layer 13 vibrates to transmit the acoustic signals. When receiving the acoustic signals, by applying a constant potential to the reference electrode layer 14, the receiving electrodes 112 receive the acoustic signals so as to realize fingerprint recognition. Moreover, the transmitting electrodes 111 and the receiving electrodes 112 are arranged on a same layer and can be formed through a one-time composition technique in specific preparation, so that the preparation process of the fingerprint recognition module can be greatly simplified and the problems of complexity of the preparation process and difficulty of realizing mass production of ultrasonic fingerprint recognition devices in the related art can be improved.

In specific implementation, as shown in FIGS. 2-5, each of the transmitting electrodes 111 is strip-shaped and the plurality of transmitting electrodes 111 extend along a same direction.

In specific implementation, the strip-shaped transmitting electrodes 111 may be located at the gaps between adjacent rows of the receiving electrodes, may also be located at the gaps between adjacent columns of the receiving electrodes, may also be directly located at positions where the rows of the receiving electrodes are located and may also be directly located at positions where the columns of the receiving electrodes are located. Specific examples will be described below for illustration.

For example, as shown in FIG. 2, the transmitting electrodes 111 are in one-to-one corresponding to the rows of the receiving electrodes 112, and one transmitting electrode 111 is arranged at the gap between every adjacent rows of the receiving electrodes 112. In the embodiment of the present disclosure, the transmitting electrodes 111 are in one-to-one corresponding to the rows of the receiving electrodes 112, i.e., once one row of the receiving electrodes 112 is arranged, one transmitting electrode 111 is arranged; and the rows of the receiving electrodes 112 and the transmitting electrodes 111 are arranged alternately in order.

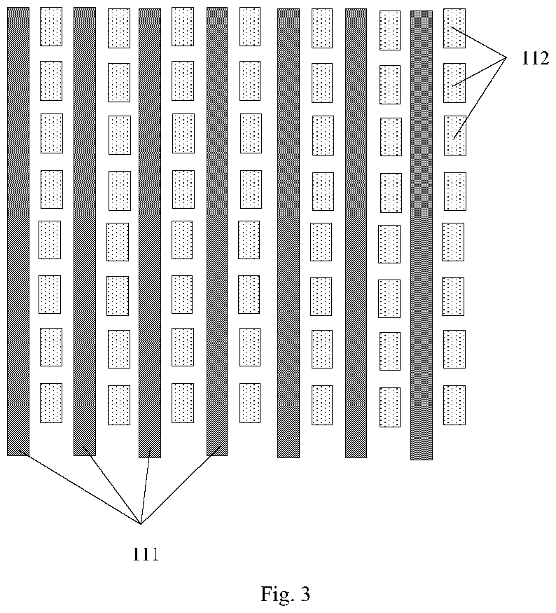

For example, as shown in FIG. 3, the transmitting electrodes 111 are in one-to-one corresponding to the columns of the receiving electrodes 112, and one transmitting electrode 111 is arranged at the gap between every adjacent columns of the receiving electrodes 112. In the embodiment of the present disclosure, the transmitting electrodes 111 are in one-to-one corresponding to the columns of the receiving electrodes 112, i.e., once one column of the receiving electrodes 112, one transmitting electrode 111 is arranged; and the columns of the receiving electrodes 112 and the transmitting electrodes 111 are arranged alternately in order.

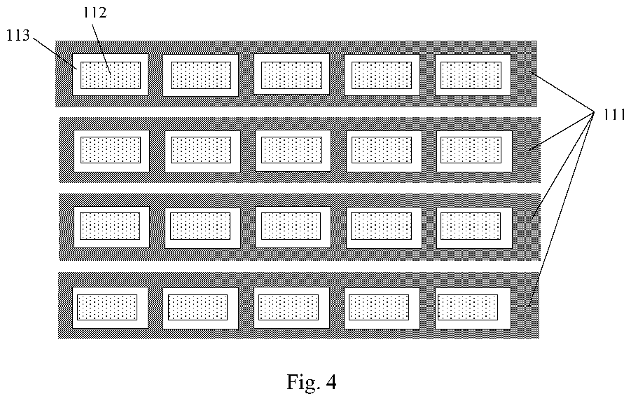

For example, as shown in FIG. 4, the transmitting electrodes 111 are in one-to-one corresponding to the rows of the receiving electrodes 112, each of the transmitting electrodes 111 surrounds one row of the receiving electrodes 112, and first hollow areas 113 are formed at positions corresponding to the receiving electrodes 112 in the row, and orthographic projections of the first hollow areas 113 on the substrate 11 cover orthographic projections of the corresponding receiving electrodes 112 on the substrate 11. In the embodiment of the present disclosure, the transmitting electrodes 112 are located at the positions where the rows of the receiving electrodes 111 are located, and the first hollow areas 113 are formed at the positions corresponding to the receiving electrodes 111, and the orthographic projections of the first hollow areas 113 on the substrate 11 cover the orthographic projections of the corresponding receiving electrodes 112 on the substrate 11; i.e., gap areas exist between the receiving electrodes 112 and the transmitting electrodes 111, to realize insulation between the transmitting electrodes 111 and the receiving electrodes 112. Optionally, the orthographic projections of the receiving electrodes 112 on the substrate 111 are rectangular, the orthographic projections of the first hollow areas 113 on the substrate 111 are also rectangular, and moreover, the centers of the orthographic projections of the receiving electrodes 112 and the first hollow areas 113 on the substrate 11 overlap and the rectangular covering areas of the orthographic projections of the first hollow areas 113 on the substrate 11 are greater than the rectangular covering areas of the orthographic projections of the receiving electrodes 112 on the substrate 11.

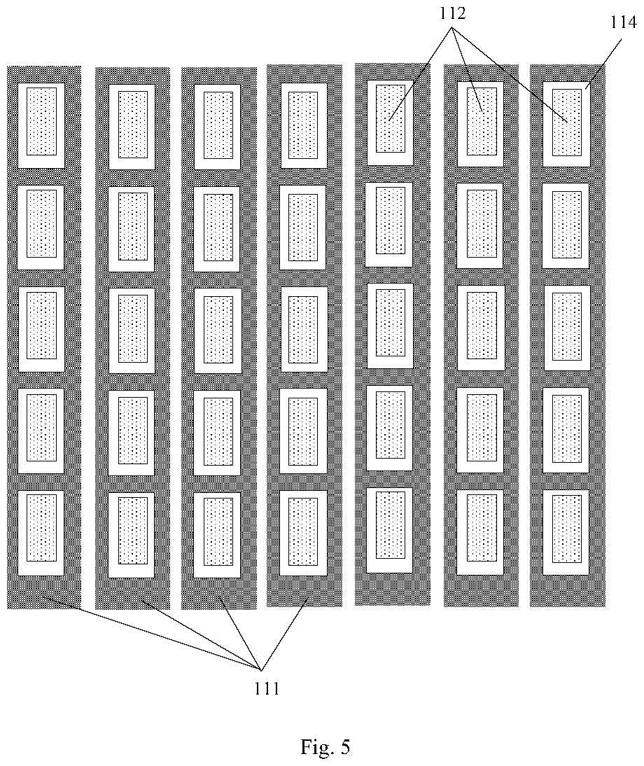

For example, as shown in FIG. 5, the transmitting electrodes 111 are in one-to-one corresponding to the columns of the receiving electrodes 112, each of the transmitting electrodes surrounds one column of the receiving electrodes 112, and second hollow areas 114 are formed at positions corresponding to the receiving electrodes 112 in the column, and orthographic projections of the second hollow areas 114 on the substrate 11 cover orthographic projections of the corresponding receiving electrodes 112 on the substrate 11. In the embodiment of the present disclosure, the transmitting electrodes 111 are located at the positions where the columns of the receiving electrodes 112 are located, and the second hollow areas 114 are formed at the positions corresponding to the receiving electrodes 112, and the orthographic projections of the second hollow areas 114 on the substrate 11 cover the orthographic projections of the corresponding receiving electrodes 112 on the substrate 11, i.e., gap areas exist between the receiving electrodes 112 and the transmitting electrodes 111, to realize insulation between the transmitting electrodes 111 and the receiving electrodes 112. Specifically, the orthographic projections of the receiving electrodes 112 on the substrate 11 are rectangular and the orthographic projections of the second hollow areas 114 on the substrate 111 are also rectangular, moreover, the centers of the orthographic projections of the receiving electrodes 112 and the second hollow areas 114 on the substrate 11 overlap, and the rectangular covering areas of the orthographic projections of the second hollow areas 114 on the substrate 11 are greater than the rectangular covering areas of the orthographic projections of the receiving electrodes 112 on the substrate 11.

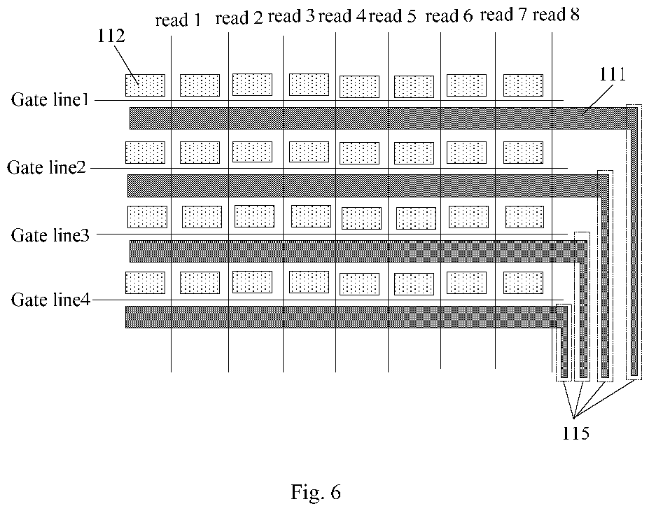

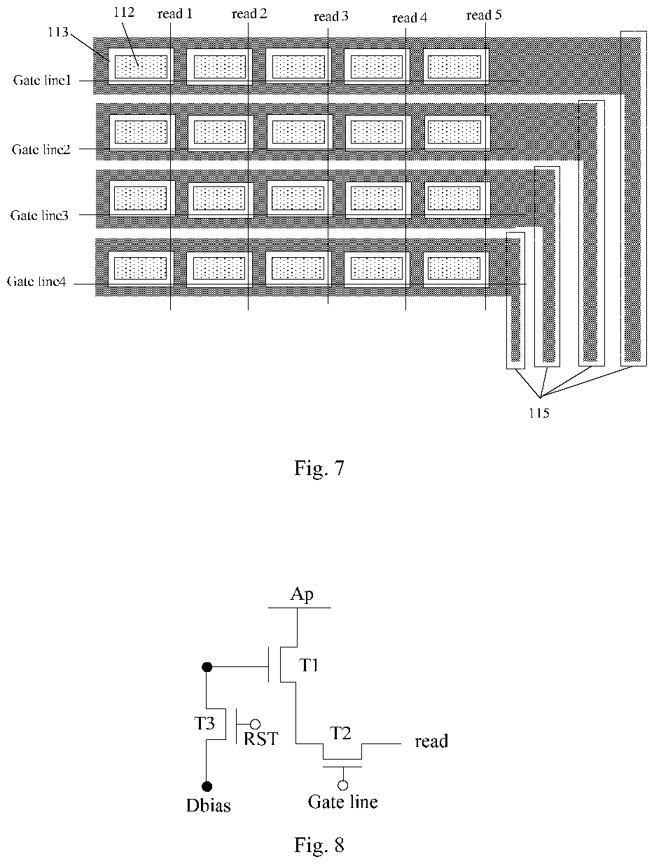

In specific implementation, as shown in FIGS. 6 and 7, the electrode layer 12 further includes transmitting connection lines 115 which are in a bezel area of the fingerprint recognition module, and the transmitting connection lines 115 are in electrical connection to the transmitting electrodes 111 in a one-to-one corresponding manner. In the embodiment of the present disclosure, the electrode layer 12 further includes the transmitting connection lines 115 in electrical connection to the transmitting electrodes 111 in a one-to-one corresponding manner, so that the transmitting connection lines 115 can also be formed while the receiving electrodes 112 and the transmitting electrodes 111 are formed, thereby further simplifying the preparation process of the fingerprint recognition module. Optionally, materials of the transmitting electrodes 111, and the receiving electrodes 112 as well as the transmitting connection lines 115 are the same and can be indium tin oxide.

In specific implementation, as shown in FIGS. 6, 7 and 8, the fingerprint recognition module further includes recognition circuits in one-to-one corresponding to the receiving electrodes, and scanning signal lines Gate line and reading signal lines read in electrical connection to the recognition circuits, wherein the recognition circuits are configured to read signals received by the receiving electrodes 112 through the reading signal lines read when the scanning signal lines Gate line are connected.

Optionally, the recognition circuits can be located between the substrate 11 and the electrode layer 12. Each of the recognition circuits can include a first transistor T1, a second transistor T2 and a third transistor T3;

a gate electrode of the first transistor T1 is electrically connected to the receiving electrode 112 and a source electrode of the third transistor T3, a source electrode of the first transistor T1 is electrically connected to a first signal terminal AP, and a drain electrode of the first transistor T1 is electrically connected to a source electrode of the second transistors T2;

a gate electrode of the second transistor T2 is electrically connected to the scanning signal line (Gate line), and a drain electrode of the second transistor T2 is electrically connected to the signal read line (read);

a gate electrode of the third transistor T3 is electrically connected to a third signal terminal RST, and a drain electrode of the third transistor T3 is electrically connected to a fourth signal terminal Dbias; and

the first transistor T1 can optionally be a source follower, and the second transistor T2 can optionally be a control switch.

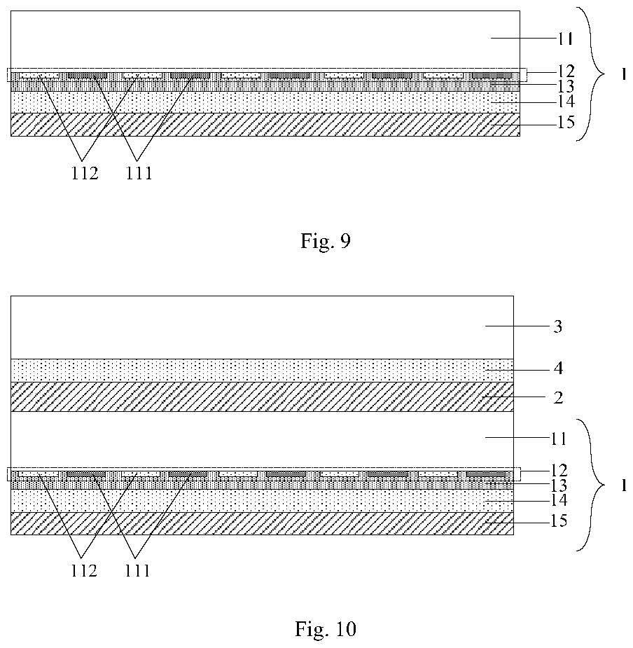

In specific implementation, as shown in FIG. 9, one side, away from the piezoelectric film layer 13, of the reference electrode layer 14 is further provided with a protection layer 15. The material of the reference electrode layer 14 can specifically be silver. In the embodiment of the present disclosure, one side, away from the piezoelectric film layer 13, of the reference electrode layer 14 is further provided with the protection layer 15, so that the reference electrode layer 14 can be protected. Optionally, the protection layer 15 is Epoxy film.

In specific implementation, the reference electrode layer 14 is a whole film layer. In the embodiment of the present disclosure, the reference electrode layer 14 is the whole film layer. When being prepared, the reference electrode layer 14 is not required to be patterned, so that the preparation process of the fingerprint recognition module can be further simplified.

In specific implementation, the piezoelectric film layer 13 is a whole film layer. The material of the piezoelectric film layer 13 can specifically be Poly vinylidene fluoride (PVDF). In the embodiment of the present disclosure, the piezoelectric film layer 13 is the whole film layer. When being prepared, the piezoelectric film layer 13 is not required to be patterned, so that the preparation process of the fingerprint recognition module can be further simplified.

In specific implementation, the substrate 11 of the embodiment of the present disclosure can be a glass substrate.

Based on the same inventive concept, as shown in FIG. 10, an embodiment of the present disclosure further provides a display device including a display panel 2 and further including the fingerprint recognition module 1 provided by the embodiment of the present disclosure, wherein the fingerprint recognition module 1 is located at a non-display side of the display panel 2. Optionally, the display panel can be an OLED display panel and one side, away from the fingerprint recognition module 2, of the display panel 1 can also be provided with a protection cover plate 3 which is laminated with the display panel 1 through an optical clear adhesive 4.

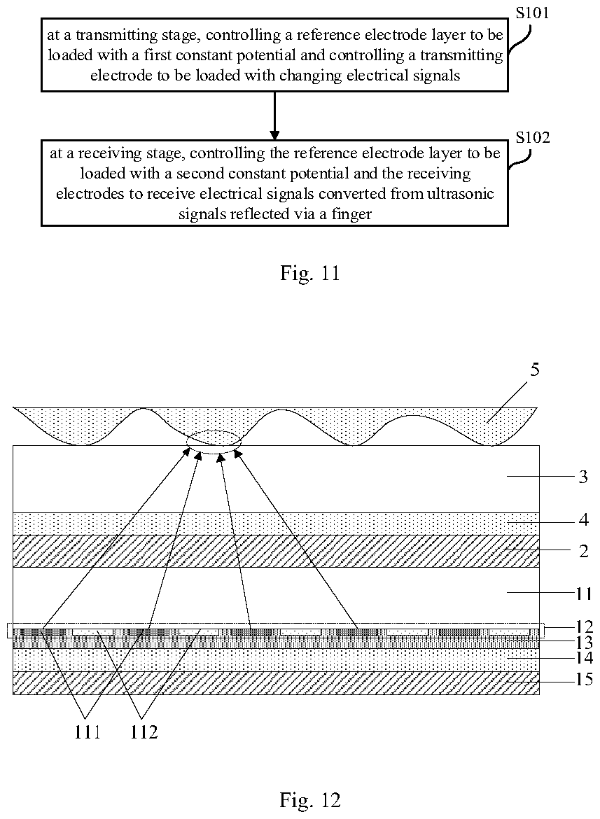

Based on the same inventive concept, as shown in FIG. 11, an embodiment of the present disclosure further provides a driving method of the fingerprint recognition module provided by the embodiment of the present disclosure, including:

S101: at a transmitting stage, controlling a common electrode layer to be loaded with a first constant potential and controlling the transmitting electrodes to be loaded with changing electrical signals; and

S102: at a receiving stage, controlling the reference electrode layer to be loaded with a second constant potential and the receiving electrodes to receive electrical signals which are converted from ultrasonic signals reflected via a finger, where the ultrasonic signals reflected via a finger are converted into the electrical signals through the piezoelectric film layer.

In specific implementation, controlling the transmitting electrodes to be loaded changing electrical signals in S101 includes:

controlling the transmitting electrodes to be loaded with the changing electrical signals in order; and

when the current transmitting electrode is loaded with the changing electrical signals, controlling the plurality of adjacent transmitting electrodes to be loaded with the electrical signals before a preset duration, so as to focus a plurality of ultrasonic signals correspondingly transformed from a plurality of electrical signals at different positions in order.

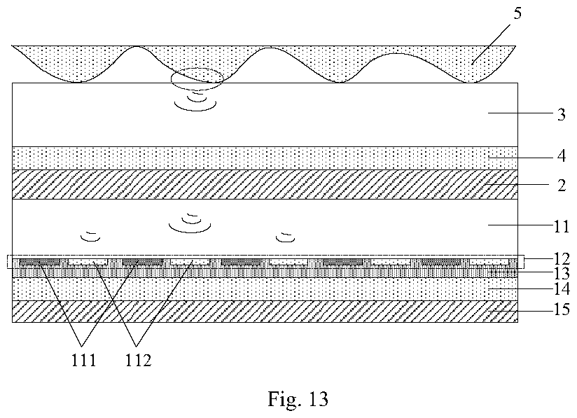

By combining what is shown in FIGS. 12-13, the specific implementation of a focus process is described as follows (with focus of four transmitting electrodes 111 as the example for description).

Firstly, driving signals are applied to a first transmitting electrode 111 from the left and a fourth transmitting electrode 111 from the left, and the driving signals are then applied to a second transmitting electrode 111 from the left and a third transmitting electrode 111 from the left. By controlling phase difference of acoustic signals, the acoustic signals are focused to a ridge position of a finger 5 just above the second receiving electrode 112 from the left, and then, the just above reflective signals are perpendicularly reflected to the second receiving electrodes 112 from the left and the second receiving electrode 112 from the left are controlled to store the reflective signals; subsequently, the recognition circuits are controlled to read the reflective signals. After the signals in the whole row are read, focusing and reading of the signals in the next row are performed. That is, the signals in one row are focused, then stored and read, which is performed in order. A reference potential can be permanently applied to the reference electrode layer 14 made from Ag material below.

As shown in FIG. 13, when focused to a valley, focused acoustic sources will be dispersed downwards, the energy under is the strongest and the energy at two sides weakens in order. In this way, the strongest signals (strengths corresponding to the ridge and the valley are different) are stored on the row of receiving electrodes 112 corresponding to the second receiving electrode 112 from the left, and the signals stored correspondingly by the first receiving electrode 112 from the left and the third receiving electrode 112 from the left are relatively weaker. During reading, a value corresponding to the second receiving electrode 112 from the left can be read only to be taken as information of each position on the row. Values of the first receiving electrode 112 from the left and the third receiving electrode 112 from the left are correspondingly added to the value of the second receiving electrode 112 from the left, and the final sum value serves as information of each position corresponding to the second receiving electrode 112 from the left.

The embodiment of the present disclosure has the following beneficial effects: the fingerprint recognition module provided by the embodiment of the present disclosure includes the substrate, the electrode layer located on one side of the substrate, the piezoelectric film layer located on one side, away from the substrate, of the electrode layer, and the reference electrode layer located on one side, away from the electrode layer, of the piezoelectric film layer, wherein the electrode layer includes the plurality of receiving electrodes arranged in an array and the plurality of transmitting electrodes located at the gaps between the receiving electrodes, and the receiving electrodes and the transmitting electrodes are insulated from each other. When the acoustic signals are transmitted, by applying the constant potential to the reference electrode layer and loading the changing electrical signals to the transmitting electrodes, the piezoelectric film layer vibrates to transmit the acoustic signals. When the acoustic signals are received, by applying the constant potential to the reference electrode layer, the receiving electrodes receive the ultrasonic signals so as to realize fingerprint recognition. Moreover, the transmitting electrodes and the receiving electrodes are arranged on a same layer and can be formed through the one-time composition technique in specific preparation, so that the preparation process of the fingerprint recognition module can be greatly simplified and the problems of complexity of the preparation process and difficulty of realizing mass production of ultrasonic fingerprint recognition devices in the related art can be improved.

Obviously, those skilled in the art can make various modifications and variations to the present disclosure without departing from the spirit and scope of the present disclosure. In this way, if the modifications and variations to the present disclosure belong to the claims of the present disclosure and equivalent techniques thereof, the present disclosure also intends to include the modifications and variations inside.

1. A fingerprint recognition module, comprising a substrate, an electrode layer located on one side of the substrate, a piezoelectric film layer located on one side, away from the substrate, of the electrode layer, and a reference electrode layer located on one side, away from the electrode layer, of the piezoelectric film layer, wherein
the electrode layer comprises a plurality of receiving electrodes arranged in an array and a plurality of transmitting electrodes located, wherein the receiving electrodes and the transmitting electrodes are insulated from each other and spaced with each other.

2. The fingerprint recognition module of claim 1, wherein the transmitting electrodes are strip-shaped and the plurality of transmitting electrodes extend along a same direction.

3. The fingerprint recognition module of claim 2, wherein the transmitting electrodes are in one-to-one corresponding to rows of the receiving electrodes, and one transmitting electrode is arranged at a gap between every adjacent rows of the receiving electrodes.

4. The fingerprint recognition module of claim 2, wherein the transmitting electrodes are in one-to-one corresponding to columns of the receiving electrodes, and one transmitting electrode is arranged at a gap between every adjacent columns of the receiving electrodes.

5. The fingerprint recognition module of claim 2, wherein the transmitting electrodes are in one-to-one corresponding to rows of the receiving electrodes, the transmitting electrodes respectively surround one row of the receiving electrodes, and a first hollow area is formed at a position corresponding to each of the receiving electrodes in rows, and an orthographic projection of the first hollow area on the substrate covers an orthographic projection of a corresponding receiving electrode on the substrate.

6. The fingerprint recognition module of claim 2, wherein the transmitting electrodes are in one-to-one corresponding to columns of the receiving electrodes, the transmitting electrodes respectively surround one column of the receiving electrodes, and a second hollow area is formed at a position corresponding to each of the receiving electrodes in columns, and an orthographic projection of the second hollow area on the substrate covers an orthographic projection of a corresponding receiving electrode on the substrate.

7. The fingerprint recognition module of claim 2, wherein the electrode layer further comprises transmitting connection lines in a bezel area of the fingerprint recognition module, wherein the transmitting connection lines are electrically connected to the transmitting electrodes in a one-to-one corresponding manner.

8. The fingerprint recognition module of claim 7, further comprises recognition circuits in one-to-one corresponding to the receiving electrodes, and scanning signal lines in electrical connection to the recognition circuits and reading signal lines in electrical connection to the recognition circuits, and the recognition circuits are configured to read signals received by the receiving electrodes through the reading signal lines in response to that the scanning signal lines are switched on.

9. The fingerprint recognition module of claim 1, wherein one side, away from the piezoelectric film layer, of the reference electrode layer is further provided with a protection layer.

10. The fingerprint recognition module of claim 1, wherein the piezoelectric film layer is a whole film layer.

11. The fingerprint recognition module of claim 1, wherein the reference electrode layer is a whole film layer.

12. A display device, comprising a display panel and further comprising the fingerprint recognition module of claim 1, the fingerprint recognition module being located at a non-display side of the display panel.

13. The display device of claim 12, wherein the transmitting electrodes are strip-shaped and the plurality of transmitting electrodes extend along a same direction.

14. The display device of claim 13, wherein the transmitting electrodes are in one-to-one corresponding to rows of the receiving electrodes, and one transmitting electrode is arranged at a gap between every adjacent rows of the receiving electrodes.

15. The display device of claim 13, wherein the transmitting electrodes are in one-to-one corresponding to columns of the receiving electrodes, and one transmitting electrode is arranged at a gap between every adjacent columns of the receiving electrodes.

16. The display device of claim 13, wherein the transmitting electrodes are in one-to-one corresponding to rows of the receiving electrodes, the transmitting electrodes respectively surround one row of the receiving electrodes, and a first hollow area is formed at a position corresponding to each of the receiving electrodes in rows, and an orthographic projection of the first hollow area on the substrate covers an orthographic projection of a corresponding receiving electrode on the substrate.

17. The display device of claim 13, wherein the transmitting electrodes are in one-to-one corresponding to columns of the receiving electrodes, the transmitting electrodes respectively surrounds one column of the receiving electrodes, and a second hollow area is formed at a position corresponding to each of the receiving electrodes in columns, and an orthographic projection of the second hollow area on the substrate covers an orthographic projection of a corresponding receiving electrode on the substrate.

18. A driving method of the fingerprint recognition module of claim 1, comprising:
at a transmitting stage, controlling a reference electrode layer to be loaded with a first constant potential and controlling the transmitting electrodes to be loaded with changing electrical signals; and
at a receiving stage, controlling the reference electrode layer to be loaded with a second constant potential and the receiving electrodes to receive electrical signals converted from ultrasonic signals reflected via a finger.

19. The driving method of claim 18, wherein the controlling the transmitting electrodes to be loaded with changing electrical signals comprises:
controlling the transmitting electrodes to be loaded with the changing electrical signals in order; and
in response to that a current transmitting electrode is loaded with the changing electrical signals, controlling a plurality of adjacent transmitting electrodes to be loaded with the electrical signals before a preset duration, so as to focus a plurality of ultrasonic signals correspondingly transformed from the plurality of electrical signals at different positions in order.

20. A position recognition method applied to the fingerprint recognition module of claim 1, comprising:
controlling the recognition circuits to read electrical signals as corresponding positional information of the receiving electrodes, wherein the electrical signals are converted from ultrasonic signals reflected via a finger and received by the receiving electrodes.
